(19) United States
(12) Patent Application Publication
(10) Pub. No.: US 2022/0408991 A1
(43) Pub. Date: Dec. 29, 2022

(54) Ferromagnetic Material Sequestering Device

(71) Applicant: Johnny Ritter, Huntsville, AL (US)

(72) Inventor: Johnny Ritter, Huntsville, AL (US)

(21) Appl. No.: 17/361,466

(22) Filed: Jun. 29, 2021

(51) Int. Cl. A47L 7/00; A47L 9/02; A47L 9/24; B03C 1/30

(52) U.S. Cl. CPC A47L 7/009; A47L 9/02; A47L 9/248; B03C 1/30

(57) ABSTRACT

A ferromagnetic material sequestering device for separating metals from a waste stream generated by a vacuum includes a shell, which has a bottom and a top. The bottom is open and a hole is positioned in the shell proximate to the top. A connector is engaged to the shell proximate to the hole engages a hose that is operationally engaged to a vacuum generator so that the vacuum generator is in fluidic communication with the shell. The vacuum generator is positioned to suction a mixture of objects through the shell. A magnet is engaged to the shell and magnetically engages ferromagnetic materials in the mixture of objects. The ferromagnetic materials thus are sequestered within the shell and can be reclaimed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sequestering devices and more particularly pertains to a new sequestering device for separating metals from a waste stream generated by a vacuum. The present invention discloses a sequestering device comprising a shell, which has a top that is configured for attachment to a hose of vacuum generator. A magnet is engaged to the shell proximate to a perimeter of a bottom of the shell, which is open. As a mixture of objects is suctioned through the shell, ferromagnetic materials are engaged by the magnet and sequestered within the shell.

### (2) Description of Related Art Including Information Disclosed Under 37 CFR 1.97 and 1.98

The prior art relates to sequestering devices for vacuum cleaners and comprises devices intended to prevent metal materials from entering the vacuum cleaners using magnets that retain the metal material outside of a head of the vacuum cleaner or within a hose of the vacuum cleaner. What is lacking in the prior art is a sequestering device comprising a shell, which has a top that is configured for attachment to a hose of vacuum generator. A magnet is engaged to the shell proximate to a perimeter of a bottom of the shell, which is open. As a mixture of objects is suctioned through the shell, ferromagnetic materials are engaged by the magnet and sequestered within the shell.

### BRIEF SUMMARY OF THE INVENTION

An embodiment of the disclosure meets the needs presented above by generally comprising a shell, which has a bottom and a top. The bottom is open and a hole is positioned in the shell proximate to the top. A connector is engaged to the shell proximate to the hole and is configured to engage a hose that is operationally engaged to a vacuum generator so that the vacuum generator is in fluidic communication with the shell. The vacuum generator is positioned to suction a mixture of objects through the shell. A magnet is engaged to the shell and is configured to magnetically engage ferromagnetic materials in the mixture of objects. The ferromagnetic materials thus are sequestered within the shell and can be reclaimed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a ferromagnetic material sequestering device according to an embodiment of the disclosure.

FIG. 2 is a front view of an embodiment of the disclosure.

FIG. 3 is a rear view of an embodiment of the disclosure.

FIG. 4 is a bottom view of an embodiment of the disclosure.

FIG. 5 is a cross-sectional view of an embodiment of the disclosure.

FIG. 6 is a side view of an embodiment of the disclosure.

FIG. 7 is an in-use view of an embodiment of the disclosure.

### DETAILED DESCRIPTION OF THE INVENTION

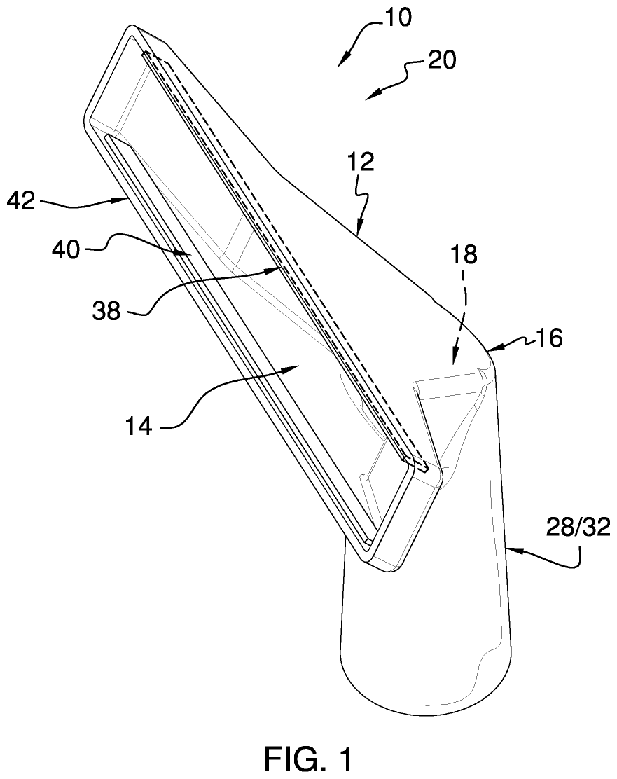

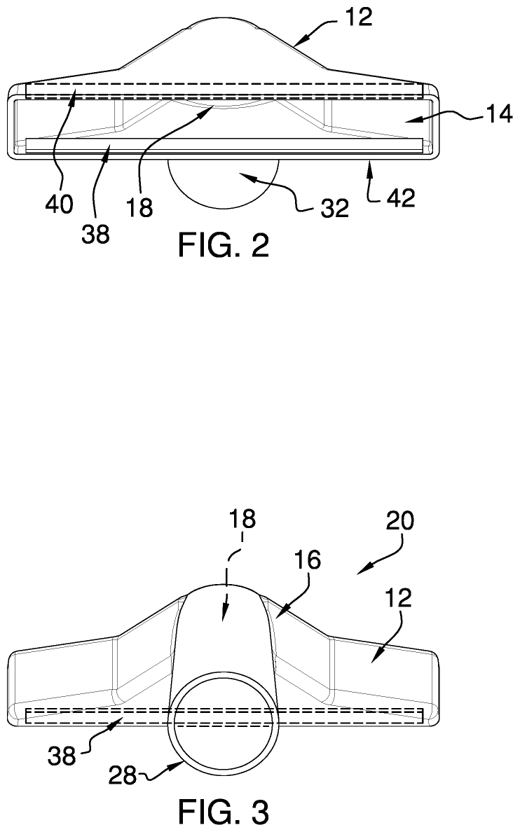

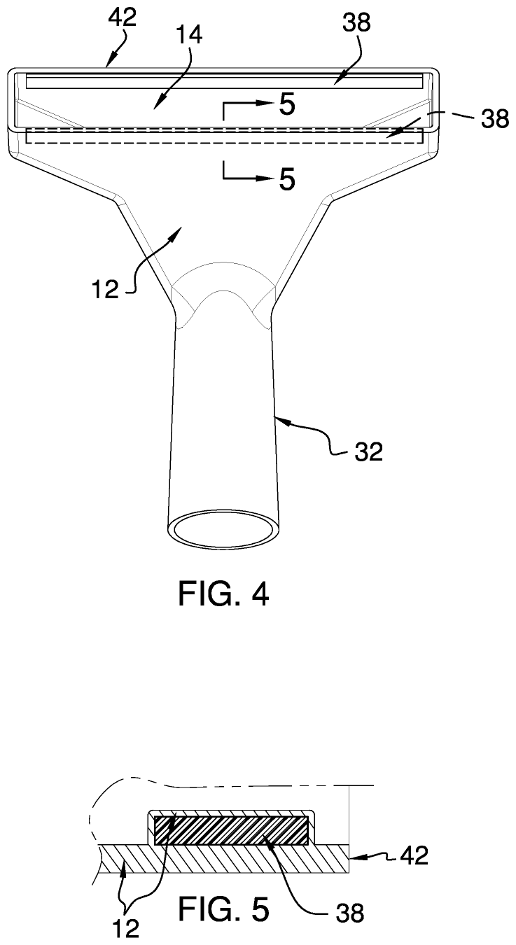

With reference now to the drawings, and in particular to FIGS. 1 through 7 thereof, a new sequestering device embodying the principles and concepts of an embodiment of the disclosure and generally designated by the reference numeral 10 will be described.

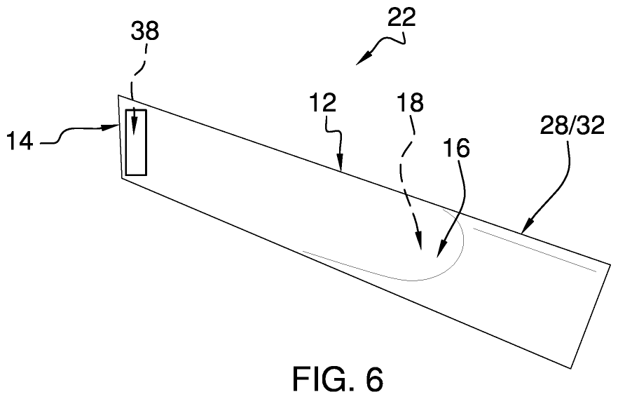

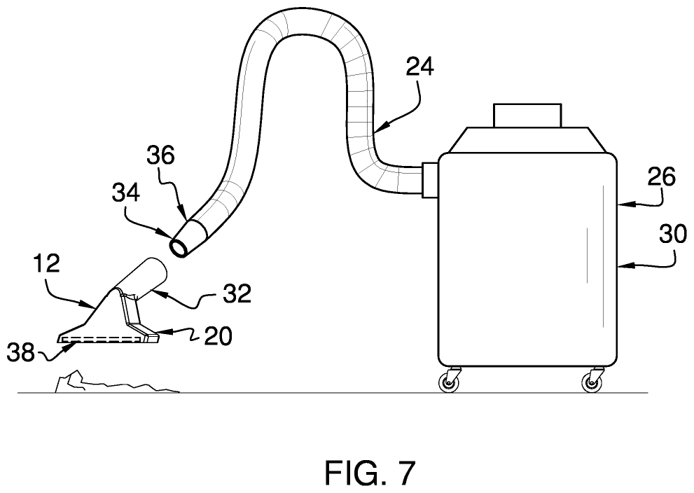

As best illustrated in FIGS. 1 through 7, the ferromagnetic material sequestering device 10 generally comprises a shell 12, which has a bottom 14 and a top 16. The bottom 14 is open and a hole 18 is positioned in the shell 12 proximate to the top 16. The shell 12 comprises plastic and thus is not ferromagnetic. The shell 12 may be shaped as a utility nozzle 20, as shown in FIG. 1, or a crevice tool 22, as shown in FIG. 6, which are configured for attachment to a hose 24 of a shop vacuum 26, as shown in FIG. 7. The present invention also anticipates the shell 12 being alternatively shaped, as attachments having a variety of shapes are used with the shop vacuum 26.

A connector 28 is engaged to the shell 12 proximate to the hole 18 and is configured to engage a hose 24 that is operationally engaged to a vacuum generator 30, such as, but not limited to, the shop vacuum 26, so that the vacuum generator 30 is in fluidic communication with the shell 12. The vacuum generator 30 is positioned to suction a mixture of objects through the shell 12. The connector 28 may comprise a first tube 32, which is configured for insertion of a second tube 34 that is engaged to a terminus 36 of the hose 24, so that the second tube 34 is frictionally engaged to the first tube 32. The connector 28 also may comprise other connecting means, such as, but not limited to, twist locks, ring clamps, threaded connections, and the like.

A magnet 38 is engaged to the shell 12 and is configured to magnetically engage ferromagnetic materials in the mixture of objects. The ferromagnetic materials thus are sequestered within the shell 12 and can be reclaimed. For example, screws, nails, and the like, in a mixture of saw dust, can be suctioned through the shell 12, with the screws and nails being sequestered by the magnet 38 for reclamation. The magnet 38 may comprise one or more rare earth metals, such as, but not limited to, molybdenum. The present invention also anticipates the magnet 38 comprising other hard ferromagnetic materials, such as, but not limited to, alnico, ferrite, and the like, as well as electromagnets.

The magnet 38 may be configured as a bar 40, as shown in FIGS. 1-6, although the present invention anticipates the magnet 38 being alternatively shaped, such as, but not limited to, ovally shaped, circularly shaped, and the like. The magnet 38 may be imbedded in the shell 12, as shown in FIG. 5. As shown in FIG. 1, the magnet 38 is positioned proximate to a perimeter 42 of the bottom 14. The magnet 38 may be one of a pair of magnets 38, with the magnets 38 of the pair of magnets 38 being opposingly positioned on the perimeter 42 of the bottom 14.

In one example of use, the utility nozzle 20 is affixed to the hose 24 of the shop vacuum 26, as shown in FIG. 7. The shop vacuum 26 is turned on and used to suction up the mixture of objects. The ferromagnetic materials are sequestered within the shell 12 and can be reclaimed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A ferromagnetic material sequestering device comprising:
a shell having a bottom and a top, the bottom being open;
a hole positioned in the shell proximate to the top;
a connector engaged to the shell proximate to the hole and being configured for engaging a hose operationally engaged to a vacuum generator, such that the vacuum generator is in fluidic communication with the shell and positioned for suctioning a mixture of objects through the shell; and
a magnet engaged to the shell, wherein the magnet is configured for magnetically engaging ferromagnetic materials in the mixture of objects, such that the ferromagnetic materials are sequestered within the shell, wherein the magnet is imbedded in the shell.

2. The ferromagnetic material sequestering device of claim 1, wherein the shell comprises plastic.

3. The ferromagnetic material sequestering device of claim 1, wherein the shell is shaped as a utility nozzle or a crevice tool configured for attachment to the hose of a shop vacuum.

4. The ferromagnetic material sequestering device of claim 1, wherein the connector comprises a first tube configured for insertion of a second tube engaged to a terminus of the hose, such that the second tube is frictionally engaged to the first tube.

5. The ferromagnetic material sequestering device of claim 1, wherein the magnet comprises one or more rare earth metals.

6. The ferromagnetic material sequestering device of claim 5, wherein the magnet comprises molybdenum.

7. The ferromagnetic material sequestering device of claim 1, wherein the magnet is configured as a bar.

8. (canceled)

9. The ferromagnetic material sequestering device of claim 7, wherein the magnet is positioned proximate to a perimeter of the bottom.

10. The ferromagnetic material sequestering device of claim 9, wherein the magnet is one of a pair of magnets, the magnets of the pair of magnets being opposingly positioned on the perimeter of the bottom.

11. A ferromagnetic material sequestering system comprising:
a vacuum generator;
a hose operationally engaged to and extending from the vacuum generator;
a shell having a bottom and a top, the bottom being open;
a hole positioned in the shell proximate to the top;
a connector engaged to the shell and to the hose, such that the vacuum generator is in fluidic communication with the shell, wherein the vacuum generator is configured for suctioning a mixture of objects through the shell; and
a magnet engaged to the shell, wherein the magnet is configured for magnetically engaging ferromagnetic materials in the mixture of objects, such that the ferromagnetic materials are sequestered within the shell, wherein the magnet is imbedded in the shell.

12. The ferromagnetic material sequestering system of claim 11, wherein:
the vacuum generator comprises a shop vacuum;
the connector comprises a first tube configured for insertion of a second tube engaged to a terminus of the hose, such that the second tube is frictionally engaged to the first tube;
the shell comprises plastic; and
the shell is shaped as a utility nozzle or a crevice tool configured for attachment to the hose.

13. The ferromagnetic material sequestering system of claim 11, wherein the magnet comprises one or more rare earth metals.

14. The ferromagnetic material sequestering system of claim 11, wherein the magnet is configured as a bar.

15. The ferromagnetic material sequestering system of claim 11, wherein the magnet is imbedded in the shell.

16. The ferromagnetic material sequestering system of claim 11, wherein the magnet is positioned proximate to a perimeter of the bottom.

17. The ferromagnetic material sequestering system of claim 16, wherein the magnet is one of a pair of magnets, the magnets of the pair of magnets being opposingly positioned on the perimeter of the bottom.

18. A ferromagnetic material sequestering device comprising:
a shell having a bottom and a top, the bottom being open, the shell comprising plastic;
a hole positioned in the shell proximate to the top;
a connector engaged to the shell proximate to the hole and being configured for engaging a hose operationally engaged to a vacuum generator, such that the vacuum generator is in fluidic communication with the shell and positioned for suctioning a mixture of objects through the shell, the connector comprising a first tube configured for insertion of a second tube engaged to a terminus of the hose, such that the second tube is frictionally engaged to the first tube;
a magnet imbedded within the shell, wherein the magnet is configured for magnetically engaging ferromagnetic materials in the mixture of objects, such that the ferromagnetic materials are sequestered within the shell, the magnet comprising one or more rare earth metals, the magnet comprising molybdenum, the magnet being configured as a bar, the magnet being positioned proximate to a perimeter of the bottom, the magnet being one of a pair of magnets, the magnets of the pair of magnets being opposingly positioned on the perimeter of the bottom; and
the shell being shaped as a utility nozzle or a crevice tool configured for attachment to a hose of a shop vacuum.
